(19) United States
(12) Patent Application Publication
(10) Pub. No.: US 2014/0189127 A1
(43) Pub. Date: Jul. 3, 2014

(54) RESERVATION AND EXECUTION IMAGE WRITING OF NATIVE COMPUTING DEVICES

(71) Applicants: Anjaneya Reddy Chagam, Chandler, AZ (US); Weijia Wang, Hillsboro, OR (US); Satpal Birak, Folsom, CA (US); Weiye Zhou, Hillsobor, OR (US); Jeffrey A. Canfield, Hillsoboro, OR (US)

(72) Inventors: Anjaneya Reddy Chagam, Chandler, AZ (US); Weijia Wang, Hillsboro, OR (US); Satpal Birak, Folsom, CA (US); Weiye Zhou, Hillsobor, OR (US); Jeffrey A. Canfield, Hillsoboro, OR (US)

(21) Appl. No.: 13/997,130

(22) PCT Filed: Dec. 27, 2012
(86) PCT No.: PCT/US12/71861

§ 371 Date: Jun. 21, 2013

(51) Int. Cl. H04L 12/911

(52) U.S. Cl. CPC H04L 47/72
USPC 709/226

(57) ABSTRACT

Embodiments of techniques and systems f associated with reserving native computing devices are described. In some embodiments, an apparatus may receive an indicator of a native computing device to be reserved for a computing client and an indicator of an execution image to be written to the native computing device. The native computing device, the computing client and the apparatus may be remotely disposed from each other. The apparatus may cause a first communication path to be established to enable the execution image to be written to the native computing device on behalf of the computing client. On completion of the writing of the execution image to the native computing device, the apparatus may cause a second communication path to be established for the native computing device to be available for computational use by the computing client. Other embodiments may be described and/or claimed.

### TECHNICAL FIELD

The present disclosure relates generally to the field of data processing, and more particularly, to techniques and systems associated with reservation, provisioning and customization of native computing devices for computational use by a computing client.

### BACKGROUND

Some cloud service providers allow clients to reserve and utilize processing resources. These resources typically take the form of virtual machines, which may be readily configured to meet a client's needs but which often exact a performance overhead of 15-20%. To avoid this overhead, customers with computationally intensive tasks may attempt to reserve time on a native processing device. However, few cloud service providers offer their clients such an option, and those that do typically limit the available image configuration and customization options, perform the configuration manually, and provide no way for clients to monitor the performance or configuration status of reserved devices.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example native computing device reservation environment, in accordance with various embodiments.

FIG. 2 is a block diagram illustrating an example reservation management system, in accordance with various embodiments.

FIG. 3 is a block diagram illustrating an example reservation interface management node, in accordance with various embodiments.

FIG. 4 is an example screen shot of a first client-facing interface that may be provided by a reservation interface management node, in accordance with various embodiments.

FIG. 5 is an example screen shot of a second client-facing interface that may be provided by a reservation interface management node, in accordance with various embodiments.

FIG. 6 is a block diagram illustrating an example communication path management node, in accordance with various embodiments.

FIG. 7 is a block diagram illustrating an example imaging management node, in accordance with various embodiments.

FIG. 8 is a block diagram illustrating an example native computing device configured for use with a reservation management system, in accordance with various embodiments.

FIG. 9 is a flow diagram of an example reservation interface process, in accordance with various embodiments.

FIG. 10 is a flow diagram of an example communication path management process, in accordance with various embodiments.

FIG. 11 is a flow diagram of an example switch instruction process, in accordance with various embodiments.

FIG. 12 is a flow diagram of an example threshold-based switch instruction process, in accordance with various embodiments.

FIG. 13 is a flow diagram of an example imaging management process, in accordance with various embodiments.

FIG. 14 is a flow diagram of an example process executable by a native computing device configured for use with a reservation management system, in accordance with various embodiments.

FIG. 15 is a flow diagram of an example imaging path indication process, in accordance with various embodiments.

FIG. 16 is a block diagram of an example computing device suitable for practicing the disclosed embodiments, in accordance with various embodiments.

### DETAILED DESCRIPTION

Embodiments of techniques and systems for managing reservations of native computing devices are described. In some embodiments, an apparatus may receive an indicator of a native computing device to be reserved for a computing client and an indicator of an execution image to be written to the native computing device. The native computing device, the computing client and the apparatus may be remotely disposed from each other. The apparatus may cause a first communication path to be established to enable the execution image to be written to the native computing device on behalf of the computing client. On completion of the writing of the execution image to the native computing device, the apparatus may cause a second communication path to be established for the native computing device to be available for computational use by the computing client.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

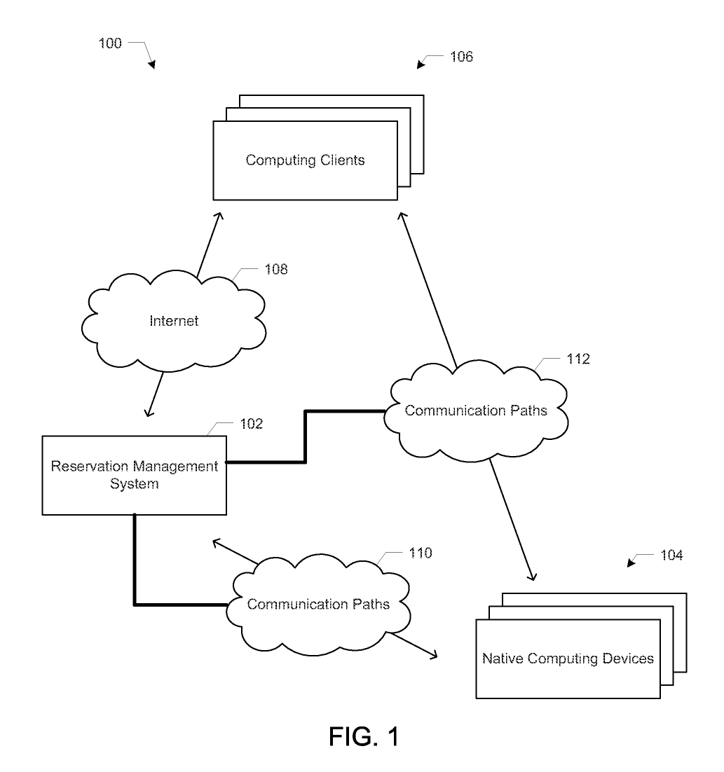

The term “native computing device” is used herein. The term, when used in the context of executing a task or configuring a device, refers to direct execution of the task on a computing device or configuration of the computing device, as opposed to execution of the task or configuration in one of a number of virtual machines instantiated on the computing device. As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. Referring now to FIG. 1, an example native computing device reservation environment 100 is illustrated, in accordance with various embodiments. Native computing device reservation environment 100 may include reservation management system 102, native computing devices 104, and computing clients 102. Native computing devices 104 may include, e.g., one or more smart phone, ultrabook, tablet, desktop, laptop, server, storage or network devices, and computing clients 106 may include, e.g., one or more desktop, tablet, ultrabook, smart phone or laptop computing devices. Computing client 106 may also include software services initiated from cloud operating environments. Reservation management system 102 may communicate with native computing devices 104 via communication paths 110. Native computing devices 104 may be remotely disposed from computing clients 106. In some embodiments, native computing devices 104 may be remotely disposed from one or more components of reservation management system 102.

Reservation management system 102 may also be configured to manage communication paths 110 (e.g., by establishing and de-establishing various paths within communication paths 110). Computing clients 106 may communicate with native computing devices 104 via communication paths 112. Reservation management system 102 may also be configured to manage communication paths 112 (e.g., by establishing and de-establishing various paths within communication paths 112). Reservation management system 102 may communicate with computing clients 106 via Internet communication paths 108. In some embodiments, computing clients 106 include one or more computing devices, such as a desktop computer, PDA, smart phone, tablet computer, ultrabook or laptop computer. Computing clients 106 may include computing devices owned or managed by one or more different entities (e.g., different organizations or customers). In some embodiments, native computing device reservation environment 100 may provide a cloud-based computing resource service to computing clients 106 with high performance computing, big data or analytics applications, for example. In some embodiments, native computing device environment 100 may provide computing resources to computing clients 106 to execute technology demonstrations, training, or testing services. As discussed below, in some embodiments, native computing device reservation environment 100 may provide self-service, on-demand provisioning and customization of native computing devices 104 to computing clients 106 in a multi-tenant cloud environment to deliver sandbox-as-a-service capabilities.

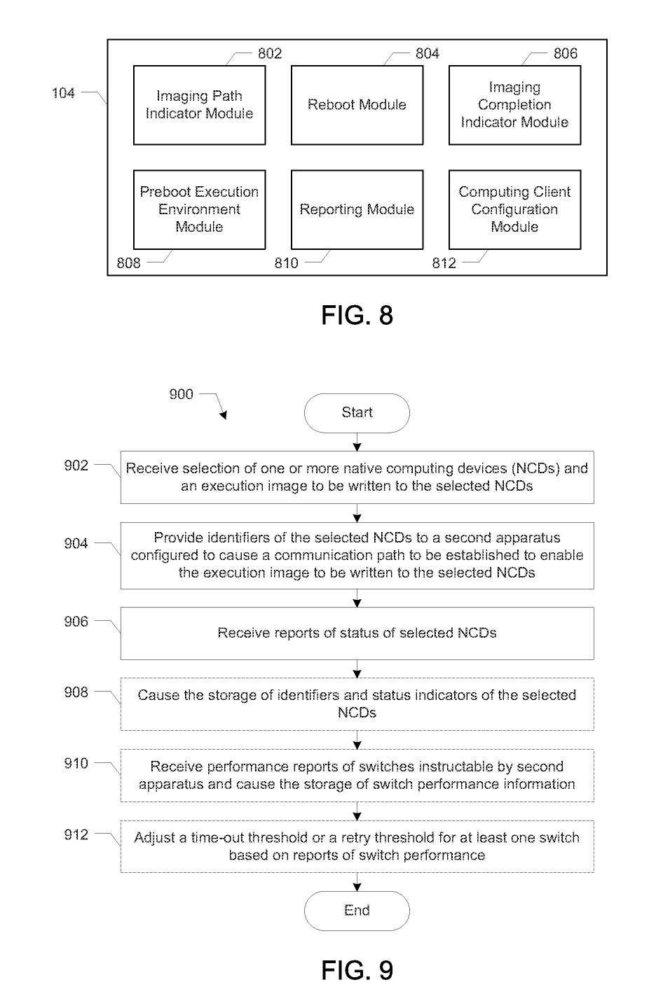

Each of native computing devices 104 may have one or several CPUs, random-access memory, storage devices, and input/output (I/O) facilities like printers, etc. Native computing devices may be any computing systems known in the art (e.g., computing servers available from Dell Computer of Austin, Tex., or Hewlett Packard of Palo Alto, Calif.). In various embodiments, a native computing device may include one or more blade servers. A blade server may include one or more multi-core processors (e.g., multi-core processors from Intel Corporation of Santa Clara, Calif.). A blade server may also include system memory, mass storage, and/or one or more networking cards/interfaces of various types. An example of a native computing device configured for use with a reservation management system (such as reservation management system 102) is described in further detail below with reference to FIG. 8. The number of native computing devices 102, the computing capacity of native computing devices 102, and the networking protocols employed by native computing devices 102 may vary from implementation to implementation, depending on the number of computationally intensive tasks to be supported concurrently, the computational intensities, and the data communication characteristics of these tasks. Embodiments of native computing devices that may be included with native computing devices 104 are discussed below with reference to FIG. 8. In some embodiments, reservation management system 102 may also manage reservations of virtual computing resources, such as virtual servers and server racks, storage devices, and network equipment (not shown).

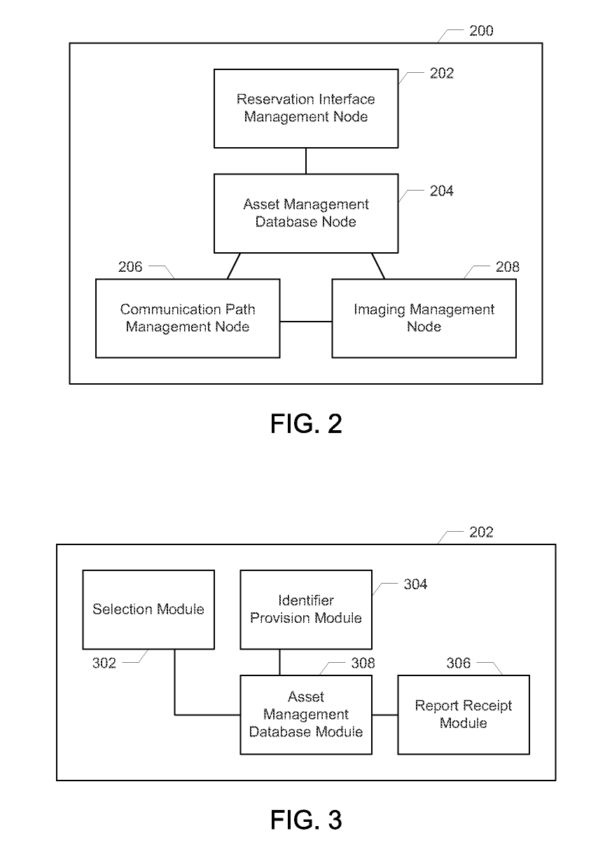

Communication paths 110 and 112 may include any high speed wired and/or wireless network or networks configured to facilitate data communication between reservation management system 102 and native computing devices 104, and between native computing devices 104 and computing clients 106, respectively (e.g., 10G Ethernet or InfiniBand). Communication paths 110 and 112 may include any of a number of high speed networking devices known in the art, such as high speed routers, switches and/or gateways. For example, high speed routers, switches and gateways available from Cisco Systems, Inc. of San Jose, Calif., Mellanox of San Jose, Calif., or Netgear, Inc. of San Jose, Calif. Communication paths 110 112 may include wired paths, wireless paths or both. Communication paths like communication paths 110 and 112 may also facilitate data communication among native computing devices included in native computing devices 104 and among various components of reservation management system 102 (e.g., the components of example reservation management system 200 of FIG. 2, discussed below). In various embodiments, communication paths 110 and communication paths 112 may be different groups of networking devices. In some embodiments, at least part of communication paths 110 and communication paths 112 may be routed over common networking devices, or may utilize different protocols over same common networking paths.

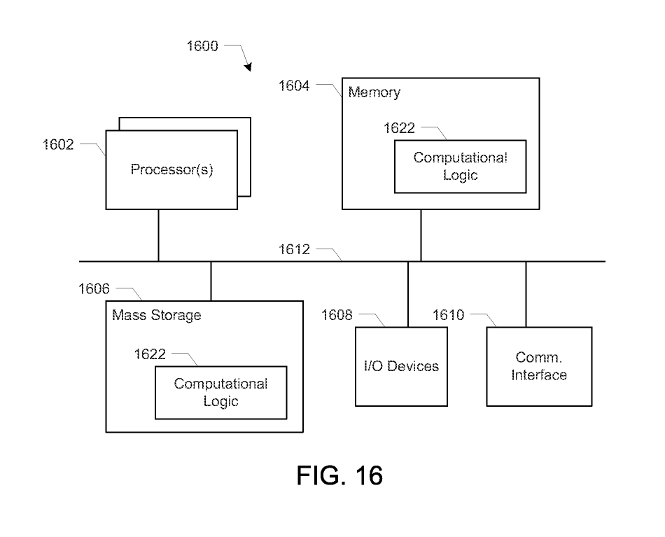

Referring now to FIG. 2, an example reservation management system 200 is illustrated, in accordance with various embodiments. The components of reservation management system 200, discussed in detail below, may be included in reservation management system 102 of FIG. 1. In some embodiments, the components of reservation management system 200 may be implemented by one or more computing devices, such as computing device 1600 of FIG. 16 (discussed below).

Reservation management system 200 may include reservation management interface node 202. Reservation management interface node 202 may be in communication with asset management database node 204. In some embodiments, reservation management interface node 202 may provide a self-service portal to computing clients (such as computing clients 106 of FIG. 1) to reserve native computing devices (such as native computing devices 104). In some embodiments, reservation management interface node 202 may provide, to computing clients, a central “dashboard” of imaging progress based on asynchronously or synchronously received reports of the status of native computing devices. In some embodiments, reservation management interface node 202 may provide computing clients with the option to reserve multiple collections of native computing devices and indicate a different execution image for writing to each collection. Embodiments of reservation management interface node 202 are discussed below with reference to FIG. 3.

Reservation management system 200 may include asset management database node 204. Asset management database node may be in communication with reservation management interface node 202, communication path management node 206, and imaging management node 208. In some embodiments, asset management database node 204 may store identifiers of each native computing device that is managed by reservation management system 200. Asset management database 204 may also store a status of each native computing device, which may indicate whether the native computing device is currently reserved or will be reserved, whether a communication path has been established between the native computing device and an image management node, whether the native computing device has been imaged with a desired execution image, whether a communication path has been established between the native computing device and a client computing environment such that the native computing device is available for computational use by the computing client, and other information about the status of the native computing device. In some embodiments, asset management database 204 may also store information about other components in native computing device reservation environment 100, such as switches whose settings determine whether various communication paths have been established. In some embodiments, asset management database 204 may store information about a communication path location of the native computing devices (e.g., a switch and port assignment). Such communication path location information may facilitate changes in the communication paths established between the native computing devices and other components (e.g., changes in port assignments such as virtual local area network (VLAN) settings). Additional examples of information that may be stored in asset management database node 204 about native computing devices and other components of a native computing device reservation environment are discussed below.

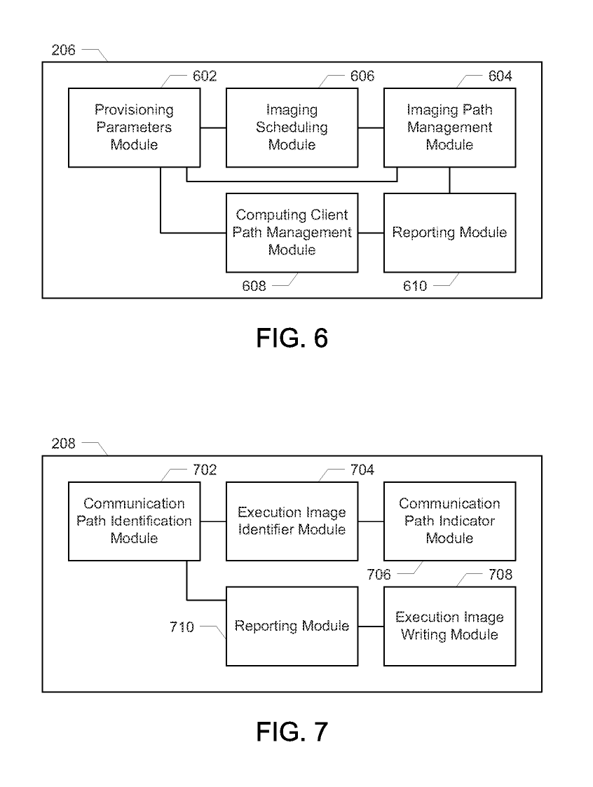

Reservation management system 200 may include communication path management node 206. Communication path management node 206 may be in communication with imaging management node 208 and asset management database node 204. In some embodiments, communication path management node 206 may control which communication paths are established among all communication paths managed by reservation management system 200. For example, communication path management node 206 may control which communication paths are established among communication paths 110 and communication paths 112 of FIG. 1. In some embodiments, communication path management node 206 may control one or more switches that variably connect different ports with which computing clients (such as computing clients 106 of FIG. 1), native computing devices (such as native computing devices 104 of FIG. 1), and components of reservation management system 200 (such as imaging management node 208) may be in communication. In some embodiments, communication path management node 206 may manipulate low level settings of components of native computing device reservation environment 100 (FIG. 1), such as switch timeout settings or other switch capabilities, to improve quality of service and reliably automate the establishment of various communication paths. In some embodiments, communication path management node 206 may establish communication paths in a multi-threaded and batched manner, which may improve performance of large-scale concurrent operations. In some embodiments, failure of one or more batches or one or more threads may not affect the performance of any other batched or threaded processes. In some embodiments, communication path management node 206 may automatically establish a communication path between a native computing device to which an execution image has been written and a client environment so that the native computing device is available for computational use by the computing client that reserved the native computing device. Embodiments of communication path management node 206 are discussed below with reference to FIG. 6.

Reservation management system 200 may include imaging management node 208. Imaging management node 208 may be in communication with asset management database node 204 and communication path management node 206. In some embodiments, imaging management node 208 may automatically determine when a communication path is established between imaging management node 208 and a native computing device, identify which execution image is to be written to the native computing device, and initiate the provisioning of the native computing device with the execution image. In some embodiments, imaging management node 208 may customize infrastructure services of native computing devices (e.g., by setting active directory domains and user accounts). In some embodiments, imaging management node 208 may support execution images that include Windows or Linux hypervisors for client or server platforms, and may support multi-language builds. Imaging management node 208 may also support the concurrent writing of different execution images to different collections of native computing devices (reserved by different computing clients or a same computing client). For example, in some embodiments, imaging management node 208 may support the imaging in a single batch of native computing devices reserved by two different computing clients. Embodiments of imaging management node 208 are discussed below with reference to FIG. 7.

Referring now to FIG. 3, an example reservation interface management node 202 is illustrated, in accordance with various embodiments. In some embodiments, the components of reservation interface management node 202 may be implemented by one or more computing devices, such as computing device 1600 of FIG. 16 (discussed below). Exemplary processes that may be executed by reservation interface management node 202 are described below with reference to FIG. 9.

Reservation interface management node 202 may include selection module 302. Selection module 302 may be in communication with asset management database module 308. Selection module 302 may receive a selection of one or more of native computing devices (such as native computing devices 104 of FIG. 1) to be reserved for a computing client (such as any of computing clients 106 of FIG. 1). Selection module 302 may also receive a selection of an execution image to be written to the selected native computing devices. In some embodiments, selection module 302 may provide a graphical user interface for receiving the selection of the native computing devices. The graphical user interface may be, for example, an Internet interface. Such an interface may serve as a portal which clients may use to browse through a catalog of native computing devices (which may include, for example, desktops, laptops, netbooks, ultrabooks, retail point-of-sale terminals, digital signs, load-balancers and servers). A client may use the interface provided by selection module 302 to select the native computing devices to be reserved. In some embodiments, the interface may allow the client to specify a starting and ending date for the reservation of each selected native computing device.

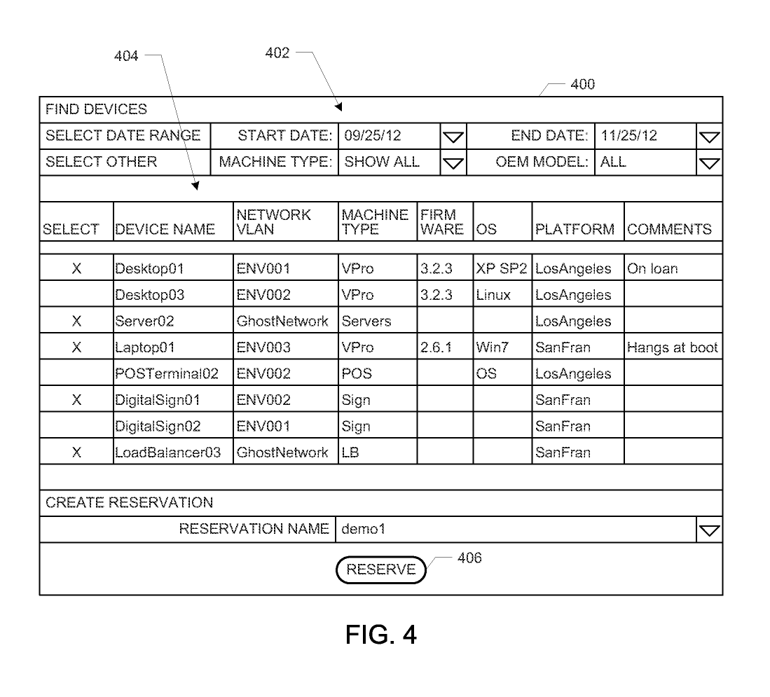

FIG. 4 is an example screen shot of a first client-facing interface 400 that may be provided by selection module 302 of reservation interface management node 202, in accordance with various embodiments. As illustrated in FIG. 4, interface 400 may be configured to receive a client selection of a time period for a reservation (via fields 402) and a client selection of one or more native computing devices for reservation (via list 404). Once all desired selections are made, interface 400 may be configured to receive a client indication (via button 406) that the native computing devices should be reserved as selected.

Returning now to FIG. 3, in some embodiments, selection module 302 may provide a graphical user interface for receiving the selection of the execution image to be written to the selected native computing devices. The graphical user interface may be, for example, an Internet interface. Such an interface may provide a menu of operating systems and hypervisors from which a client may choose to provision the selected native computing devices (e.g., as selected via interface 400 of FIG. 4). In some embodiments, an interface is configured to receive client selections of desired native computing devices, desired operating systems, and other desired provisioning settings. Upon receipt of these selections, selection module 302 may cause the storage of one or more of the received selections in an asset management database (such as asset management database node 204 of FIG. 2) via asset management database module 308.

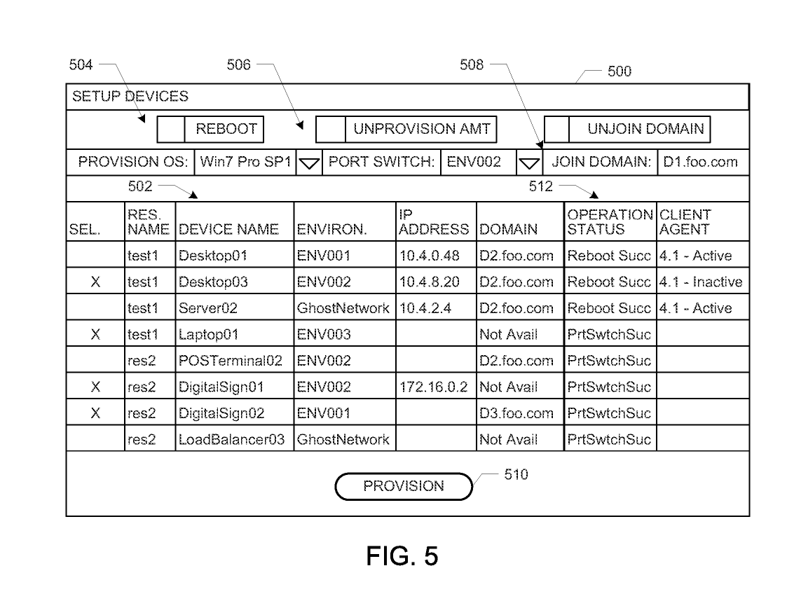

FIG. 5 is an example screen shot of a second client-facing interface 500 that may be provided by selection module 302 of reservation interface management node 202, in accordance with various embodiments. As illustrated in FIG. 5, interface 500 may be configured to receive a client selection of one or more native computing devices (via list 502), one or more operating systems (via dropdown 504), and one or more customizations (via, e.g., port switch dropdown 506 and join domain dropdown 508). Once all desired selections are made, interface 500 may be configured to receive a client indication (via button 510) that the native computing devices should be provisioned as selected. Interface 500 may also include operation status fields 512 which may display a status of the native computing devices. Operation status fields 512 may allow a client to monitor the progress of provisioning of a reserved native computing device. The information included in operation status fields 512 may be retrieved from an asset management database (such as asset management database node 204 of FIG. 2) via asset management database module 308.

Returning now to FIG. 3, reservation interface management node 202 may include identifier provision module 304. Identifier provision module 304 may be in communication with asset management database module 308. Identifier provision module 304 may provide identifiers of the selected native computing devices to another component of reservation management system 200 (FIG. 2) for further processing. In some embodiments, identifier provision module 304 may provide identifiers of the selected native computing devices to communication path management node 206 (FIG. 2). As discussed below with reference to communication path management node 206 of FIG. 6, a communication path management node may use the identifiers of the native computing devices to cause a communication path to be established to enable the execution image to be written to each selected native computing device. In some embodiments, the identifiers of the selected native computing devices may be media access control (MAC) addresses.

Reservation interface management node 202 may include report receipt module 306. Report receipt module 306 may be in communication with asset management database module 308. Report receipt module 306 may receive reports of statuses of the selected native computing devices from other components of a native computing device reservation environment (such as native computing device reservation environment 100 of FIG. 1). For example, in some embodiments, report receipt module 306 may receive reports of native computing device status from communication path management node 206 (FIG. 2). In some embodiments, report receipt module 306 may receive reports of native computing device status from the native computing devices themselves.

Reservation interface management node 202 may also include asset management database module 308. Asset management database module 308 may communicate with an asset management database (such as asset management database node 204 of FIG. 2) in order to retrieve information from and write information to the asset management database. Many examples of such information are described herein. For example, in some embodiments, asset management database module 308 may cause the storage of, for each of the plurality of native computing devices, an identifier of the native computing device and a status indicator of the native computing device. The status indicator may be based on status reports received by report receipt module 306.

In some embodiments, report receipt module 306 may receive reports of performance of other components of a native computing device management environment (such as native computing device management environment 100 of FIG. 1). For example, in some embodiments, report receipt module may receive reports of the performance of one or more switches instructable by communication path management node 206 (FIG. 2). Asset management database module 308 may cause the storage of information about the performance of such switches, based on the reports, in an asset management database. Reports about switch performance may include values of any of a number of switch performance metrics, such as a value of a retry metric or a value of a time-out metric. In some embodiments, an asset management database may store additional information about switches or other components (for example a switch model identifier, a switch firmware identifier, a switch internet protocol address, a switch subnet mask, a switch module, and/or an application programming interface (“API”) revision identifier). Reports may be received asynchronously and/or synchronously. In some embodiments, report receipt module 306 receives reports from one or more components of native computing device reservation environment 100 indicating the success or failure of one or more native computing device reservation operations.

In some embodiments, asset management database module 308 may be configured to adjust one or more settings associated with components of a native computing device reservation environment (such as native computing device reservation environment 100 of FIG. 1) to improve performance. For example, in some embodiments, asset management database module 308 may be configured to adjust a time-out threshold or a retry threshold for a switch based on received reports of performance of that switch. By extending a time-out threshold for a particular switch, more switch-related operations may complete successfully before time-out, thus reducing failures and the delays associated with retries. In some embodiments, asset management database module 308 may adjust component settings in view of quality of service requirements or objectives. By adjusting settings of components of the native computing device reservation environment, management database module 308 may perform multi-casting, error handling and recovery during the provisioning of native computing devices according to client-provided parameters.

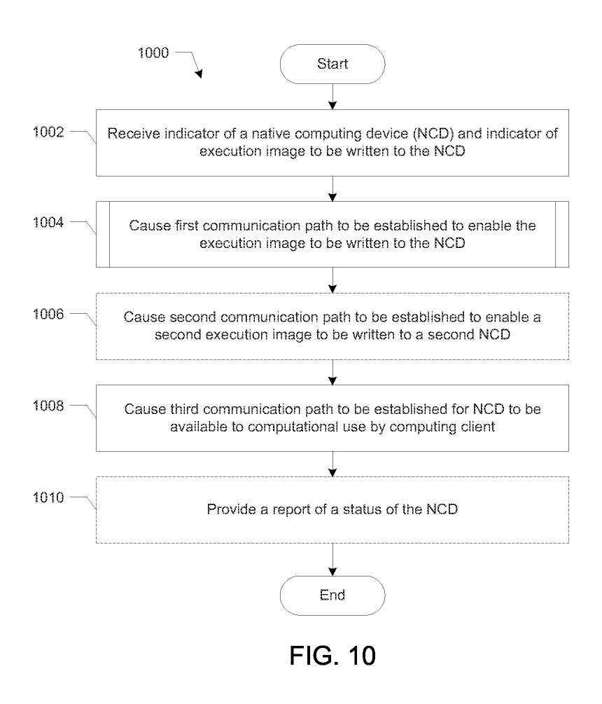

Referring now to FIG. 6, an example communication path management node 206 is illustrated, in accordance with various embodiments. In some embodiments, the components of communication path management node 206 may be implemented by one or more computing devices, such as computing device 1600 of FIG. 16 (discussed below). Exemplary processes that may be executed by communication path management node 206 are described below with reference to FIGS. 10-12.

Communication path management node 206 may include provisioning parameters module 602. Provisioning parameters module 602 may be in communication with imaging path management module 606. Provisioning parameters module 602 may receive an indicator of a first native computing device (such as any of native computing devices 104 of FIG. 1) to be reserved for a computing client (such as any of computing clients 106 of FIG. 1). Provisioning parameters module 602 may also receive an indicator of a first execution image to be written to the first native computing device.

Communication path management node 206 may include imaging path management module 604. Imaging path management module 604 may cause a first communication path to be established to enable the first execution image to be written to the first native computing device on behalf of the computing client. In some embodiments, imaging path management module 604 may establish one or more of communication paths 110 between native computing devices 104 and reservation management system 102 (FIG. 1). In particular, imaging path management module 604 may establish a first communication path between the first native computing device and imaging node 208 of reservation management system 200 (FIG. 2) to enable the first execution image to be written to the first native computing device. In some embodiments, the first communication path may comprise a VLAN communication path. In some embodiments, the establishment of the first communication path may be performed by instructions authenticated by security certificates. In some embodiments, the establishment of the first communication path may be performed in accordance with a secure shell (“SSH”) protocol.

In some embodiments, imaging path management module 604 may cause the first communication path to be established by switching one or more switches instructable by communication path management node 206. For example, in some embodiments, imaging path management module 604 may determine a first port with which the first native computing device is in communication (e.g., by querying an asset management database, such as asset management database node 204 of FIG. 2), and may instruct at least one switch to switch the first native computing device from the first port to a second port with which an imaging management node (such as imaging management node 208 of FIG. 2) is in communication. The imaging management node may be configured to write the first execution image to the first native computing device (e.g., upon establishment of the first communication path). In some embodiments, instructing at least one switch includes performing one or more switch application programming interface (“API”) calls. These API calls may be performed over a secure channel (e.g., via security certificate-based authentication).

In some embodiments, imaging path management module 604 may cause a second communication path to be established to enable a second execution image to be written to a second native computing device. The second execution image may be different from the first execution image (to be written to the first native computing device). Indicators of the second native computing device and the second execution image may be received at provisioning parameters module 602 (as discussed above with reference to the first native computing device and the first execution image). In some embodiments, the second execution image is to be written to the second native computing device substantially in parallel with the writing of the first execution image to the first native computing device. In some embodiments, the writing of the second execution image to the second native computing device may occur over a second communication path specified by, for example, a hostname assigned to the second native computing device and identified using the MAC address or other identifier of the second native computing device.

Communication path management node 206 may include imaging scheduling module 606. Imaging scheduling module 606 may be in communication with provisioning parameters module 602 and imaging path management module 604. In some embodiments, imaging scheduling module 606 may monitor the provisioning parameters received at provisioning parameters module 602 to determine how to efficiently schedule the imaging of native computing devices. For example, imaging scheduling module 606 may batch imaging tasks according to the execution images to be written to various native computing devices. Imaging scheduling module 606 may also manage multi-threaded imaging of various native computing devices. In some embodiments, imaging scheduling module 606 may monitor a total number of other native computing devices to be written with the same execution image as the first native computing device. When the total number reaches a threshold, imaging scheduling module 606 may communicate with imaging path management module 604 to cause the first communication path to be established.

Communication path management node 206 may include computing client path management module 608. Computing client path management module 608 may be in communication with provisioning parameters module 602 and imaging path management module 604. In some embodiments, on completion of the writing of the first execution image to the first native computing device (i.e., via the first communication path established by imaging path management module 604), computing client path management module 608 may cause a third communication path to be established for the first native computing device to be available for computational use by the computing client. In some embodiments, computing client path management module 608 may establish one or more of communication paths 112 between native computing devices 104 and computing clients 106 (FIG. 1). In some embodiments, computing client path management module 608 may cause the third communication path to be established by switching one or more switches instructable by communication path management node 206, as discussed above with reference to imaging path management module 604. For example, computing client path management module 608 may instruct at least one switch to switch the first native computing device from the second port (in communication with an imaging management node) to a third port in communication with the computing client. In some embodiments, the third communication path may comprise a virtual local area network (VLAN) communication path. In some embodiments, the establishment of the third communication path may be performed by instructions authenticated by security certificates. In some embodiments, the establishment of the third communication path may be performed in accordance with a secure shell (SSH) protocol.

Communication path management node 206 may include reporting module 610. Reporting module 610 may be in communication with imaging path management module 604 and computing client path management module 608. In some embodiments, reporting module 610 may provide a report of a status of the first native computing device for storage in an asset management database (such as asset management database node 204 of FIG. 2). As discussed above, a status report may include any of a number of different types of information about a status of a native computing device. For example, in some embodiments, a report provided by reporting module 610 may include a message such as execution image write in progress, reboot success, reboot failure, port switch success, port switch failure and execution image write completed. Reports may be provided asynchronously and/or synchronously. In some embodiments, reporting module 610 may provide reports from one or more of the components of communication path management node 206 indicating the success or failure of one or more operations performed by the components.

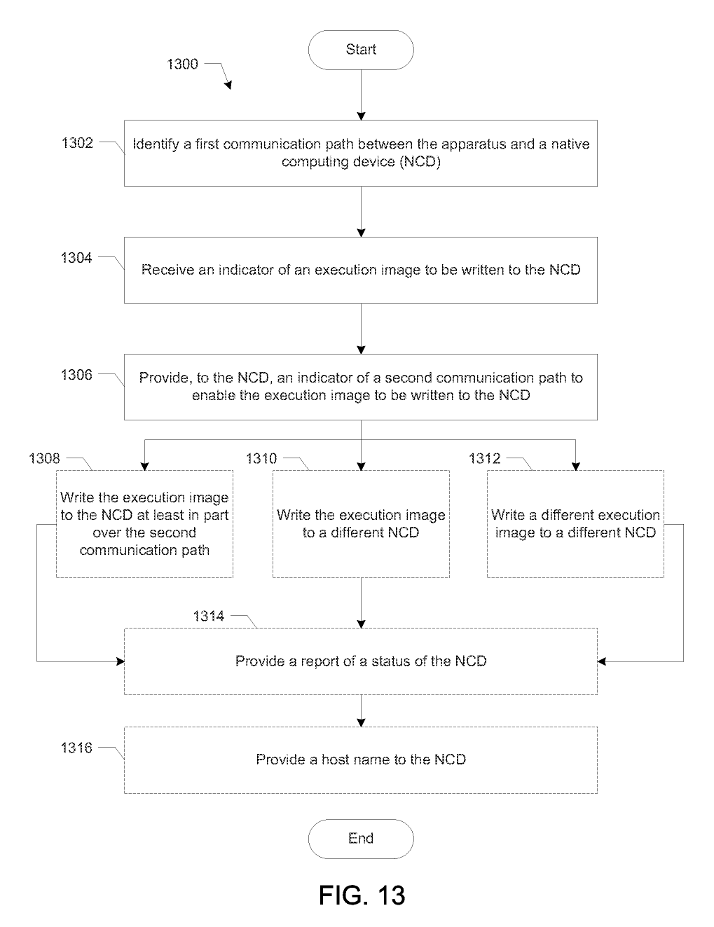

Referring now to FIG. 7, an example imaging management node 208 is illustrated, in accordance with various embodiments. In some embodiments, the components of imaging management node 208 may be implemented by one or more computing devices, such as computing device 1600 of FIG. 16 (discussed below). Exemplary processes that may be executed by imaging management node 208 are described below with reference to FIG. 13.

Imaging management node 208 may include communication path identification module 702. Communication path identification module 702 may identify a first communication path between imaging management node 208 and a native computing device reserved by a computing client.

Imaging management node 208 may include execution image identifier module 704. Execution image identifier module 704 may be in communication with communication path identification module, and may be configured to identify the native computing device with which a communication path is identified by communication path identification module 702. Execution image identifier module 704 may receive an indicator of an execution image to be written to the native computing device. In some embodiments, the indicator of the execution image may be received from an asset management database (e.g., asset management database node 204 of FIG. 2). Execution image identifier module 704 may query an asset management database using an identifier of the native computing device (e.g., a MAC address) in order to determine which execution image is to be written to the native computing device.

Imaging management node 208 may include communication path indicator module 706. Communication path indicator module 706 may provide, to the native computing device, an indicator of a second communication path to enable the execution image to be written to the native computing device. In some embodiments, preboot execution environment (PXE) scripts may be stored at a network location accessible by the native computing device and by execution image writing module 708 (e.g., over a communication path indicated by communication path indicator module 706). In such embodiments, communication path indicator module 706 may provide a network location or other communication path indicator to the native computing device, and the PXE scripts may use this indicator to connect to an appropriate computing resource configured to write the specified execution image to the native computing device. In some implementations, the indicator of the second communication path may indicate, for example, a Windows ghosting server or a Linux PXE server.

Imaging management node 208 may include execution image writing module 708. Execution image writing module 708 may write the indicated execution image to the native computing device. Execution image writing module 708 may write the image at least in part over the second communication path provided to the native computing device by communication path indicator module 706. In some embodiments, execution image writing module 708 may write the execution image to a different native computing device substantially in parallel with writing the execution image to the native computing device. In some embodiments, execution image writing module 708 may write a different execution image to a different native computing device substantially in parallel with writing the execution image to the native computing device. In some embodiments, execution image writing module 708 may further customize the native computing device according to provisioning parameters provided by a computing client (e.g., as stored in an asset management database such as asset management database node 204 of FIG. 2). For example, on completion of the writing of the execution image to the native computing device, execution image writing module 708 may provide a host name for the native computing device to the native computing device.

Imaging management node 208 may include reporting module 710. Reporting module 710 may be in communication with communication path identification module 702 and execution image writing module 708. In some embodiments, on completion of the writing of the execution image to the native computing device (e.g., via execution image writing module 708), reporting module 710 may provide a report of a status of the native computing device. The report may be provided to, for example, an asset management database (such as asset management database node 204 of FIG. 2). Reports may be provided asynchronously and/or synchronously. In some embodiments, reporting module 710 may provide reports from one or more of the components of imaging management node 208 indicating the success or failure of one or more operations performed by the components.

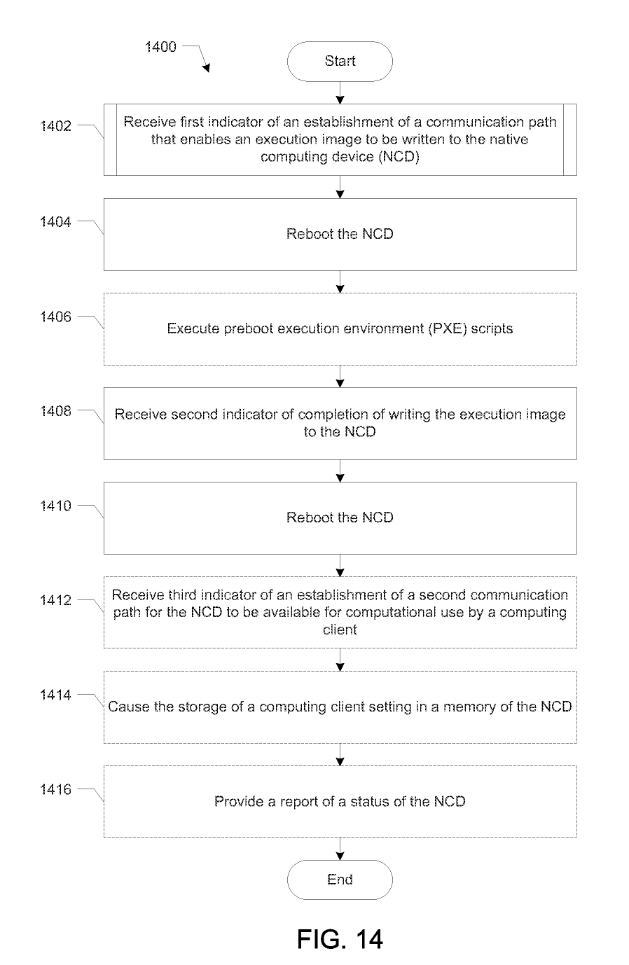

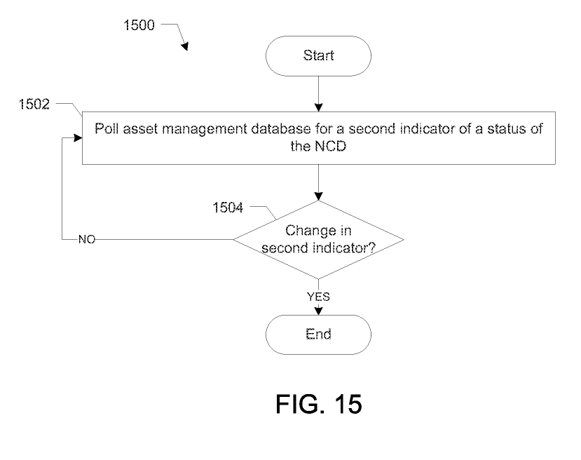

Referring now to FIG. 8, an example native computing device 104 configured for use with a reservation management system (such as reservation management system 200 of FIG. 2) is illustrated, in accordance with various embodiments. In some embodiments, the components of native computing device 104 may be implemented by one or more computing devices, such as computing device 1600 of FIG. 16 (discussed below). In some embodiments, the components of native computing device 104 may be implemented by a programmed agent executing on a computing system. Exemplary processes that may be executed by native computing device 104 are described below with reference to FIGS. 14-15.

Native computing device 104 may include imaging path indicator module 802. Imaging path indicator module 802 may be in communication with reboot module 804. Imaging path indicator module 802 may receive a first indicator of establishment of a communication path that enables an execution image to be written to native computing device 104 on behalf of a computing client that has reserved native computing device 104. The communication path may be established by, for example, communication path management node 206 of FIG. 6. The communication path may be, for example, one of communication paths 110 of FIG. 1. The communication path may be, for example, a communication path between native computing device 104 and imaging node 208 of reservation management system 200 (FIG. 2). In some embodiments, imaging node path indicator module 802 receives the first indicator by polling an asset management database (such as asset management database node 204 of FIG. 2) for an indicator of a status of native computing device 100 and detecting a change in the status indicator reflecting the establishment of the communication path.

Native computing device 104 may include reboot module 804. Reboot module may be in communication with imaging path indicator module 802 and imaging completion indicator module 806. In some embodiments, in response to receiving the first indicator of the establishment of a communication path that enables an execution image to be written to native computing device 104, reboot module 804 may reboot native computing device 104. In some embodiments, rebooting native computing device 104 may allow PXE scripts included in PXE module 808 (discussed below) to execute and initiate the imaging of native computing device 104. In some embodiments, in response to receiving an indicator of the establishment of a communication path for native computing device 104 to be available for computational use by the computing client (via computing client configuration module 810, discussed below), reboot module 804 may reboot the apparatus.

Native computing device 104 may include PXE module 808. After reboot module 804 causes a reboot of native computing device 104 in response to receiving the first indicator, PXE module 808 may execute PXE scripts during a pre-boot phase to initiate a process for writing the execution image to native computing device 104. In some embodiments, native computing device 104 may join a Ghostcast session to load the PXE scripts. In some embodiments, the PXE scripts may identify the execution image and may initiate an operating system build process. In some embodiments, the PXE scripts may execute using a communication path provided by an imaging management node (such as imaging management node 208 of FIG. 7).

Native computing device 104 may include imaging completion indicator module 808. Imaging completion indicator module 808 may be in communication with PXE module 806 and reporting module 812. Imaging completion indicator module 808 may receive an indicator of completion of the writing of the execution image to native computing device 104. The indicator may be received from, for example, PXE module 806 or from an imaging management node (such as imaging management node 208 of FIG. 7).

Native computing device 104 may include computing client configuration module 810. Computing client configuration module 810 may be in communication with reporting module 812. In some embodiments, after reboot module 804 reboots native computing device 104 in response to receive an indicator that imaging is complete, computing client configuration module 810 may receive an indicator of establishment of a communication path for native computing device 104 to be available for computational use by the computing client. In some embodiments, in response to receiving this indicator, computing client configuration module may cause the storage of a computing client setting in a memory of native computing device 104. Examples of computing client settings that may be stored include a security console setting, a security certificate (e.g., an 802.1x certificate), an active directory setting, an administrator setting, and a wireless network setting. In some embodiments, the computing client settings stored by computing client configuration module 810 may not be readily stored prior to the establishment of a communication path between native computing device 104 and the computing client. For example, in some embodiments, certain computing client settings may not be set until native computing device 104 is included in the computing client's sandbox.

Native computing device 104 may include reporting module 812. Reporting module 812 may be in communication with imaging path indicator module 802, imaging completion indicator module 808 and computing client configuration module 810. Reporting module 812 may provide a report of a status of native computing device 104 for storage in an asset management database (such as asset management database node 204 of FIG. 2). The report may include information received from any of the components of native computing device 104. Reports may be provided asynchronously and/or synchronously. In some embodiments, reporting module 812 may provide reports from one or more of the components of native computing device 104 indicating the success or failure of one or more operations performed by the components.

Referring now to FIG. 9, a flow diagram of an example reservation interface process 900 is illustrated, in accordance with various embodiments. It may be recognized that, while the operations of process 900 (and the other processes described herein) are arranged in a particular order and illustrated once each, in various embodiments, one or more of the operations may be repeated, omitted or performed out of order. For illustrative purposes, operations of process 900 may be described as performed by reservation management interface node 202 of reservation management system 200 (FIG. 2), but process 900 may be performed by any suitably configured component of reservation management system 200. Process 900 may begin at operation 902 in which reservation management interface node 202 may receive a selection of one or more of a plurality of native computing devices to be reserved for a computing client and a selection of an execution image to be written to the selected native computing devices. In some embodiments, reservation management interface node 202 may provide an Internet interface at operation 902 for receiving the selection of the one or more of the plurality of native computing devices and the selection of the execution image (e.g., as discussed above with reference to FIGS. 4 and 5). At operation 904, reservation management interface node 202 may provide identifiers of the selected native computing devices to a second apparatus. The second apparatus may be configured to cause a communication path to be established to enable the execution image to be written to each selected native computing device. The selected native computing devices may be remotely disposed from the reservation management interface node 202. In some embodiments, the identifier of the native computing device may include a MAC address. At operation 906, reservation management interface node 202 may receive reports of statuses of the selected native computing devices from the second apparatus and from the selected native computing devices.

At optional operation 908, reservation management interface node 202 may cause the storage of, for each of the selected native computing devices, an identifier of the native computing device and a status indicator of the native computing device. The status indicator may be based on the reports received at operation 906. At optional operation 910, reservation management interface node 202 may receive reports of performance of a plurality of switches instructable by the second apparatus, and may cause the storage of information about switch performance based on the received reports. In some embodiments, a report of switch performance may include, for at least one of the plurality of switches, a value of a retry metric or a value of a time-out metric. In some embodiments, information about switch performance may be stored in an asset management database, and the asset management database may further store additional information about the plurality of switches, such as a switch model identifier, a switch firmware identifier, and an API revision identifier. At optional operation 912, reservation management interface node 202 may adjust a time-out threshold or a retry threshold for a switch based on received reports of performance of that switch. Process 900 may then end.

Referring now to FIG. 10, a flow diagram of an example communication path management process 1000 is illustrated, in accordance with various embodiments. For illustrative purposes, operations of process 1000 may be described as performed by communication path management node 206 of reservation management system 200 (FIG. 2), but process 1000 may be performed by any suitably configured component of reservation management system.

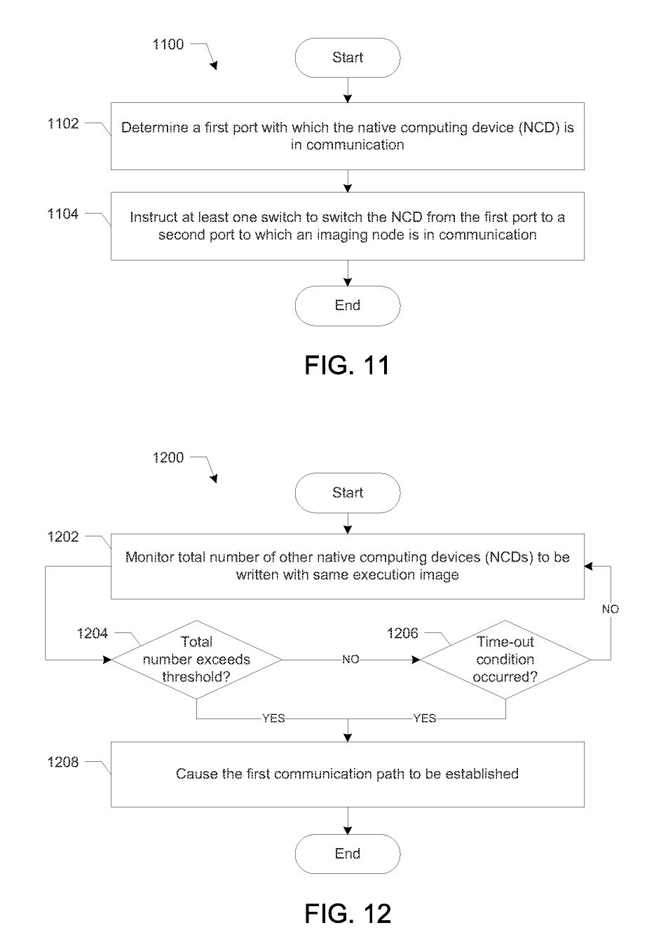

Process 1000 may begin at operation 1002 in which communication path management node 206 may receive an indicator of a native computing device to be reserved for a computing client and an indicator of an execution image to be written to the native computing device. In some embodiments, the native computing device, the computing client and the apparatus may be remotely disposed from each other. In some embodiments, reservation management system 200 may receive the execution image from the computing client (e.g., as a data file) and may cause the storage of the execution image in a storage location accessible by imaging management node 208. In some embodiments, the computing client may upload the execution image (customized as desired by the computing client) to reservation management system 200 (e.g., via a web or other network interface). At operation 1004, communication path management node 206 may cause a first communication path to be established to enable the execution image to be written to the native computing device on behalf of the computing client. Additional examples of operation 1004 are discussed below with reference to FIGS. 11 and 12.

At optional operation 1006, communication path management node 206 may cause a third communication path to be established to enable a second execution image, different from the execution image, to be written to a second native computing device. In some embodiments, the second execution image is to be written to the second native computing device substantially in parallel with the writing of the execution image to the native computing device. In some embodiments, operation 1006 may be performed in parallel with, or prior to, operation 1004.

On completion of the writing of the execution image to the native computing device, at operation 1008, communication path management node 206 may cause a second communication path to be established for the native computing device to be available for computational use by the computing client. In some embodiments, at operation 1008, communication path management node 206 may instruct at least one switch to switch the native computing device from the second port to a third port in communication with the computing client. At optional operation 1010, communication path management node 206 may provide a report of a status of the native computing device for storage in an asset management database. In some embodiments, the report provided at operation 1010 includes a message selected from the group consisting of reboot success, reboot failure, port switch success, and port switch failure. Process 1000 may then end.

Referring now to FIG. 11, a flow diagram of an example switch instruction process 1100 is illustrated, in accordance with various embodiments. As indicated above, process 1100 may be executed as part of operation 1004 of FIG. 10. Accordingly, for illustrative purposes, operations of process 1100 may be described as performed by communication path management node 206 of reservation management system 200 (FIG. 2). At operation 1101, communication path management node 206 may determine a first port with which the native computing device is in communication. At operation 1104, communication path management node 206 may instruct at least one switch to switch the native computing device from the first port to a second port with which an imaging node is in communication. The imaging node (which may be, for example, execution image writing module 706 of imaging management module 208 of FIG. 7) may be configured to write the execution image to the native computing device. In some embodiments, instructing at least one switch to switch the native computing device from the first port to a second port includes performing one or more switch API calls. Process 1100 may then end.

Referring now to FIG. 12, a flow diagram of an example threshold-based switch instruction process 1200 is illustrated, in accordance with various embodiments. As indicated above, process 1200 may be executed as part of operation 1004 of FIG. 10. Accordingly, for illustrative purposes, operations of process 1200 may be described as performed by communication path management node 206 of reservation management system 200 (FIG. 2). At operation 1202, communication path management node 206 may monitor a total number of native computing devices to be written with the same execution image as the native computing device. At decision block 1204, communication path management node 206 may determine whether the total number exceeds a threshold number. If not, communication path management node 206 may proceed to decision block 1206 and may determine whether a time-out condition has occurred. In some embodiments, a time-out condition may occur when a threshold amount of time has elapsed from a particular start time (e.g., a time at which a first instruction to write the execution image was received, or a time at which the most recent instruction to write the execution image was received). The threshold amount of time may be fixed or dynamic. For example, in some embodiments, the threshold amount of time decreases as the load on the native computing device reservation environment 100 decreases in order to balance the responsiveness of the imaging process against the available computing bandwidth. If communication path management node 206 determines at decision block 1206 that a time-out condition has not occurred, communication path management node 206 may continue to execute operation 1202 and monitor the total number. If communication path management node 206 determines that the total number exceeds the threshold, communication path management node 206 may execute operation 1208 and cause the first communication path to be established. In some embodiments, the threshold number may be one native computing device. In such embodiments, the communication path may be established upon determining that a single native computing device is to be written with the execution image.

Referring now to FIG. 13, a flow diagram of an example imaging management process 1300 is illustrated, in accordance with various embodiments. For illustrative purposes, operations of process 1300 may be described as performed by imaging management node 208 of reservation management system 200 (FIG. 2), but process 1300 may be performed by any suitably configured component of reservation management system. At operation 1302, imaging management node 208 may identify a first communication path between imaging management node 208 and a native computing device reserved by a computing client. At operation 1304, imaging management node 208 may receive an indicator of an execution image to be written to the native computing device. The indicator may be received from a database, such as asset management database node 204 of FIG. 2. At operation 1306, imaging management node 208 may provide, to the native computing device, an indicator of a second communication path to enable the execution image to be written to the native computing device. In some embodiments, PXE scripts may be stored at a network location accessible by the native computing device.

Optional operations 1308, 1310 and 1312 may be performed substantially in parallel. In some embodiments, operations 1308, 1310 and 1312 may be performed in any order. At operation 1308, imaging management node 208 may write the execution image to the native computing device at least in part over the second communication path. At operation 1310, imaging management node may write the execution image to a different native computing device. At operation 1312, imaging management node may write a different execution image to a different native computing device.

At optional operation 1314, imaging management node 208 may, on completion of the writing of the execution image to the native computing device, provide a report of a status of the native computing device. In some embodiments, the report may be provided to an asset management database. At optional operation 1316, imaging management node 210 may, on completion of the writing of the execution image to the native computing device, provide a host name for the native computing device to the native computing device.

Referring now to FIG. 14, a flow diagram of an example process 1400 executable by a native computing device (such as any of native computing devices 104 of FIG. 1) configured for use with a reservation management system (such as reservation management system 102 of FIG. 1), in accordance with various embodiments. For illustrative purposes, operations of process 1400 may be described as performed by native computing device 104 (FIG. 8), but process 1400 may be performed by any suitably configured native computing device. At operation 1402, native computing device 104 may receive a first indicator of establishment of a communication path that enables an execution image to be written to native computing device 104 on behalf of a computing client that has reserved native computing device 104. The computing client may be remotely disposed from native computing device 104. Additional examples of operation 1402 are discussed below with reference to FIG. 15. At operation 1404, native computing device 104 may, in response to receiving the first indicator at operation 1402, reboot itself. At optional operation 1406, after rebooting at operation 1404 in response to receiving the first indicator at operation 1402, native computing device 104 may execute PXE scripts to initiate a process for writing the execution image to native computing device 104.

At operation 1408, native computing device 104 may receive a second indicator of completion of the writing of the execution image to native computing device 104. At operation 1410, in response to receiving the second indicator at operation 1408, native computing device 104 may reboot itself. At optional operation 1412, after rebooting at operation 1410 in response to receiving the second indicator at operation 1408, native computing device 104 may receive a third indicator of establishment of a second communication path for native computing device 104 to be available for computational use by the computing client. At optional operation 1414, in response to receiving the third indicator at operation 1412, native computing device 104 may cause the storage of a computing client setting in a memory of the apparatus. In some embodiments, the computing client setting may include a security console setting, a security certificate, an active directory setting, an administrator setting, and/or a wireless network setting. In some embodiments, the computing client setting may include additional software installation and customization (e.g., a MICROSOFT SQL Server install and database setup). At optional operation 1416, on completion of the establishment of the second communication path (as indicated by the third indicator received at operation 1412), native computing device 104 may provide a report of a status of the apparatus (e.g., for storage in an asset management database).

Referring now to FIG. 15, a flow diagram of an example imaging path indication process 1500 is illustrated, in accordance with various embodiments. As indicated above, process 1500 may be executed as part of operation 1402 of FIG. 14. Accordingly, for illustrative purposes, operations of process 1500 may be described as performed by native computing device 104 (FIG. 8). At operation 1502, native computing device 104 may poll an asset management database (such as asset management database node 204 of FIG. 2) for a second indicator of a status of native computing device 104. At decision block 1504, native computing device 104 may determine whether a change in the second indicator has occurred. If not, native computing device may continue to execute operation 1502 and poll the asset management database. If native computing device 104 determines that a change in the second indicator has occurred, process 1500 may end and native computing device 104 may determine that a first indicator has been received of establishment of a communication path that enables an execution image to be written to native computing device 104 on behalf of a computing client that has reserved native computing device 104.

FIG. 16 is a block diagram of an example computing device suitable for practicing the disclosed embodiments, in accordance with various embodiments. As shown, computing device 1600 includes a number of processors or processor cores 1602, and system memory 1604. For the purpose of this application, including the claims, the terms “processor” and “processor cores” may be considered synonymous, unless the context clearly requires otherwise. Additionally, computing system 1600 may include mass storage devices 1606 (such as diskette, hard drive, compact disc read only memory (CDROM) and so forth), input/output devices 1608 (such as display, keyboard, cursor control and so forth) and communication interfaces 1610 (such as network interface cards, modems and so forth). The elements may be coupled to each other via system bus 1612, which represents one or more buses. In the case of multiple buses, they may be bridged by one or more bus bridges (not shown).

Each of these elements may perform its conventional functions known in the art. In particular, system memory 1604 and mass storage 1606 may be employed to store a working copy and a permanent copy of the programming instructions implementing the method of any of FIGS. 9-15, or portions thereof, herein collectively denoted as computational logic 1622. The various components may be implemented by assembler instructions supported by processor(s) 1602 or high-level languages, such as, for example, C, that can be compiled into such instructions.

The permanent copy of the programming instructions may be placed into permanent storage 1606 in the factory, or in the field, through, for example, a machine-accessible distribution medium (not shown), such as a compact disc (CD), or through communication interface 1610 (e.g., from a distribution server (not shown)). That is, one or more distribution media having an implementation of the agent program may be employed to distribute the agent and program various computing devices. The constitution of elements 1602-1612 are known, and accordingly will not be further described.

Machine-accessible media (including non-transitory computer-readable storage media), methods, systems and devices for performing the above-described techniques are illustrative examples of embodiments disclosed herein. Additionally, other devices in the above-described interactions may be configured to perform various disclosed techniques.

### Examples and Other Notes

Example 1A is a method performed by a reservation interface management node, including: receiving, by the reservation interface management node, a selection of one or more of a plurality of native computing devices to be reserved for a computing client and a selection of an execution image to be written to the selected native computing devices; providing, by the reservation interface management node, identifiers of the selected native computing devices to a second apparatus to cause the second apparatus to establish a communication path to enable the execution image to be written to each selected native computing device, wherein the selected native computing devices are to be remotely disposed from the reservation interface management node; and receiving, by the reservation interface management node, reports of statuses of the selected native computing devices from the second apparatus and from the selected native computing devices.

Example 1B is the method of Example 1A and also includes receiving, by the reservation interface management node, reports of performance of a plurality of switches instructable by the second apparatus; and causing, by the reservation interface management node, storage of information about switch performance based on the received reports.

Example 1C is the method of Example 1B, and further specifies that a report of switch performance includes, for at least one of the plurality of switches, a value of a retry metric or a value of a time-out metric.

Example 1D is the method of Example 1B, and further specifies that the information about switch performance is stored in an asset management database, wherein the asset management database is configured to store additional information about the plurality of switches selected from the group consisting of a switch model identifier, a switch firmware identifier, a switch internet protocol address, a switch subnet mask, a switch module, and an application programming interface (API) revision identifier.

Example 1E may include the subject matter of any of Examples 1B-1D, and also includes adjusting, by the reservation interface management node, a time-out threshold or a retry threshold for a switch based on received reports of performance of that switch.

Example 1F may include the subject matter of any of Examples 1B-1E, and also includes the identifier of the native computing device including a MAC address.

Example 1G may include the subject matter of any of Examples 1B-1F, and also includes causing storage of, for each of the selected native computing devices, an identifier of the native computing device and a status indicator of the native computing device, the status indicator based on the reports.

Example 1H may include the subject matter of any of Examples 1B-1G, and also includes providing an Internet interface to receive the selection of the one or more of the plurality of native computing devices and the selection of the execution image.

Example 1I is at least one machine-accessible medium including instructions stored therein that are configured to cause a reservation interface management node, in response to execution of the instructions by the reservation management interface node, to perform the method of any of Examples 1A-1H.

Example 1J is a reservation management interface node including one or more modules to perform the method of any of Examples 1A-1H.

Example 1K is a reservation management interface node including one or more means for performing the operations of the method of any of Examples 1A-1H.

Example 2A is a method performed by a native computing device, including: receiving, by the native computing device, a first indicator of establishment of a communication path that enables an execution image to be written to the native computing device on behalf of a computing client that has reserved the native computing device, wherein the computing client is to be remotely disposed from the native computing device; in response to receiving the first indicator, rebooting, by the native computing device, the native computing device; receiving, by the native computing device, a second indicator of completion of the writing of the execution image to the native computing device; in response to receiving the second indicator, rebooting, by the native computing device, the native computing device.

Example 2B may include the subject matter of Example 2A, and also includes after rebooting in response to receiving the second indicator, receiving, by the native computing device, a third indicator of establishment of a second communication path for the native computing device to be available for computational use by the computing client; and in response to receiving the third indicator, causing, by the native computing device, the storage of a computing client setting in a memory of the native computing device.

Example 2C may include the subject matter of Example 2B, and further specifies that the computing client setting is selected from the group consisting of a security console setting, a security certificate, an active directory setting, an administrator setting, a wireless network setting, a software installation and a software customization.

Example 2D may include the subject matter of any of Examples 2B-2C, and also includes providing, by the native computing device, a report of a status of the native computing device for storage in an asset management database, on completion of the establishment of the second communication path.

Example 2E may include the subject matter of any of Examples 2A-2D, and also includes executing preboot execution environment (PXE) scripts to initiate a process for writing the execution image to the native computing device after reboot in response to receive the first indicator.

Example 2F may include the subject matter of any of Examples 2A-2E, and also includes polling an asset management database for a second indicator of a status of the native computing device, wherein receive the first indicator includes detect a change in the second indicator.

Example 2G is at least one machine-accessible medium including instructions stored therein that are configured to cause a native computing device, in response to execution of the instructions by the native computing device, to perform the method of any of Examples 2A-2F.

Example 2H is a native computing device including one or more modules to perform the method of any of Examples 2A-2F.

Example 2I is a native computing device including one or more means for performing the operations of the method of any of Examples 2A-2F.

Example 3A is a method performed by a communication path management node, including: receiving, by the communication path management node, an indicator of a native computing device to be reserved for a computing client and an indicator of an execution image to be written to the native computing device, wherein the native computing device, the computing client and the communication path management node are to be remotely disposed from each other; causing, by the communication path management node, a first communication path to be established to enable the execution image to be written to the native computing device on behalf of the computing client; and on completion of the writing of the execution image to the native computing device, causing, by the communication path management node, a second communication path to be established for the native computing device to be available for computational use by the computing client.

Example 3B includes the subject matter of Example 3A, and further specifies that causing a first communication path to be established includes: monitoring a total number of other native computing devices to be written with the same execution image as the native computing device; and when the total number reaches a threshold or when a time-out condition occurs, causing the first communication path to be established.

Example 3C includes the subject matter of any of Examples 3A and 3B, and further includes causing, by the communication path management node, a third communication path to be established to enable a second execution image to be written to a second native computing device, wherein the second execution image is different from the execution image; wherein writing the second execution image to the second native computing device occurs substantially in parallel with writing the execution image to the native computing device.

Example 3D includes the subject matter of any of Examples 3A-3C, and further includes providing, by the communication path management node, a report of a status of the native computing device for storage in an asset management database.

Example 3E includes the subject matter of any of Examples 3A-3D, and further specifies that the report includes a message selected from the group consisting of execution image write in progress, reboot success, reboot failure, port switch success, port switch failure and execution image write completed.

Example 3F includes the subject matter of any of Examples 3A-3E, and further specifies that cause a first communication path to be established includes: determine a first port with which the native computing device is in communication; and instruct at least one switch to switch the native computing device from the first port to a second port with which an imaging node is in communication, the imaging node configured to write the execution image to the native computing device.

Example 3F includes the subject matter of Example 3E, and further specifies that instruct at least one switch to switch the native computing device from the first port to a second port includes perform one or more switch application programming interface (API) calls.

Example 3G includes the subject matter of any of Examples 3A-3F, and further specifies that cause a second communication path to be established includes instruct at least one switch to switch the native computing device from the second port to a third port in communication with the computing client.

Example 3H includes the subject matter of any of Examples 3A-3G, and further includes receiving the execution image from the computing client and causing storage of the execution image in a storage location accessible by the imaging node.

Example 3I is at least one machine-accessible medium including instructions stored therein that are configured to cause a communication path management node, in response to execution of the instructions by the communication path management node, to perform the method of any of Examples 3A-3H.

Example 3J is a communication path management node including one or more modules to perform the method of any of Examples 3A-3H.

Example 3K is a communication path management node including one or more means for performing the operations of the method of any of Examples 3A-3H.

Example 4A is a method performed by an imaging management node, including: identifying, by the imaging management node, a first communication path between the imaging management node and a native computing device reserved by a computing client; receiving, from a database, an indicator of an execution image to be written to the native computing device; and providing, by the imaging management node, to the native computing device, an indicator of a second communication path to enable the execution image to be written to the native computing device.

Example 4B includes the subject matter of Example 4A, and further includes writing, by the imaging management node, the execution image to the native computing device at least in part over the second communication path.

Example 4C includes the subject matter of Example 4B, and further includes, substantially in parallel with writing the execution image to the native computing device, writing, by the imaging management node, the execution image to a different native computing device.

Example 4D includes the subject matter of any of Examples 4A-4C, and further includes, on completion of the writing of the execution image to the native computing device, providing, by the imaging management node, a host name for the native computing device.

Example 4E includes the subject matter of any of Examples 4A-4D, and further includes accessing preboot execution environment (PXE) scripts stored at an accessible network location, the network location also to be accessible by the native computing device.

Example 4F includes the subject matter of any of Examples 4A-4E, and further includes providing, to an asset management database, a report of a status of the native computing device on completion of the writing of the execution image to the native computing device.

Example 4G is at least one machine-accessible medium including instructions stored therein that are configured to cause an imaging management node, in response to execution of the instructions by the imaging management node, to perform the method of any of Examples 4A-4F.

Example 4H is an imaging management node including one or more modules to perform the method of any of Examples 4A-4F.

Example 4I is an imaging management node including one or more means for performing the operations of the method of any of Examples 4A-4F.

Example 5A is a method performed by a client computing device, including: displaying, by the client computing device, information about a native computing device available for reservation; receiving, by the client computing device, a selection, from a user input of the client computing device, of an execution image to be written to the native computing device; providing, by the client computing device, the selection to a reservation management system, the reservation management system to be disposed remotely from the client computing device; and after providing the selection to the reservation management system, displaying, by the client computing device, an indicator of progress of provisioning the native computing device with the selected execution image.

Example 5B includes the subject matter of Example 5A, and further specifies that receiving a selection of an execution image to be written to the native computing device includes receiving a selection of an operating system for the native computing device.

Example 5C includes the subject matter of any of Examples 5A and 5B, and further specifies that receiving a selection of an execution image to be written to the native computing device includes receiving a selection of a port switch setting for the native computing device or a domain setting for the native computing device.

Example 5D includes the subject matter of any of Examples 5A-5C, and further specifies that the selection is provided to the reservation management system via an Internet communication path.

Example 5E includes the subject matter of any of Examples 5A-5D, and further includes synchronously or asynchronously updating, by the client computing device, the displayed indicator in accordance with a status of the native computing device stored in a database of the reservation management system.

Example 5F is at least one machine-accessible medium including instructions stored therein that are configured to cause a client computing device, in response to execution of the instructions by the client computing device, to perform the method of any of Examples 5A-5E.

Example 5G is a client computing device including one or more modules to perform the method of any of Examples 5A-5E.

Example 5H is a client computing device including one or more means for performing the operations of the method of any of Examples 5A-5E.

Example 6 is a reservation management system, including: a reservation interface management node in accordance with either of Examples 1J and 1K; a communication path management node in accordance with either of Examples 3J and 3K, communicatively coupled with the reservation interface management node; an imaging management node in accordance with either of Examples 4H and 4I, communicatively coupled with the communication path management node; and a native computing device in accordance with either of Examples 2H and 2I, communicatively coupled with the imaging management node.

Example 7 is a computing arrangement, including: a reservation interface management node configured to perform the method of any of Examples 1A-1H; a communication path management node configured to perform the method of any of Examples 3A-3H, communicatively coupled with the reservation interface management node; an imaging management node configured to perform the method of any of Examples 4A-4F, communicatively coupled with the communication path management node; and a native computing device configured to perform the method of any of Examples 2A-2F, communicatively coupled with the imaging management node.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1. A reservation interface management node, comprising:
a first module to receive a selection of one or more of a plurality of native computing devices to be reserved for a computing client and a selection of an execution image to be written to the selected native computing devices;
a second module, communicatively coupled with the first module, to provide identifiers of the selected native computing devices to a second apparatus to cause the second apparatus to establish a communication path to enable the execution image to be written to each selected native computing device, wherein the selected native computing devices are to be remotely disposed from the reservation interface management node; and
a third module, communicatively coupled with the second module, to receive reports of statuses of the selected native computing devices from the second apparatus and from the selected native computing devices.

2. The reservation interface management node of claim 1, wherein the identifier of the native computing device comprises a MAC address.

3. The reservation interface management node of claim 1, further comprising:
a fourth module communicatively coupled with the third module, and configured to cause storage of, for each of the selected native computing devices, an identifier of the native computing device and a status indicator of the native computing device, the status indicator based on the reports.

4. The reservation interface management node of claim 1, wherein the first module is further to provide an Internet interface to receive the selection of the one or more of the plurality of native computing devices and the selection of the execution image.

5. A method performed by a reservation interface management node, comprising:
receiving, by the reservation interface management node, a selection of one or more of a plurality of native computing devices to be reserved for a computing client and a selection of an execution image to be written to the selected native computing devices;
providing, by the reservation interface management node, identifiers of the selected native computing devices to a second apparatus to cause the second apparatus to establish a communication path to enable the execution image to be written to each selected native computing device, wherein the selected native computing devices are to be remotely disposed from the reservation interface management node; and
receiving, by the reservation interface management node, reports of statuses of the selected native computing devices from the second apparatus and from the selected native computing devices.

6. The method of claim 5, further comprising:
receiving, by the reservation interface management node, reports of performance of a plurality of switches instructable by the second apparatus; and
causing, by the reservation interface management node, storage of information about switch performance based on the received reports.

7. The method of claim 6, wherein a report of switch performance comprises, for at least one of the plurality of switches, a value of a retry metric or a value of a time-out metric.

8. The method of claim 6, wherein the information about switch performance is stored in an asset management database, wherein the asset management database is configured to store additional information about the plurality of switches selected from the group consisting of a switch model identifier, a switch firmware identifier, a switch internet protocol address, a switch subnet mask, a switch module, and an application programming interface revision identifier.

9. The method of claim 6, further comprising:
adjusting, by the reservation interface management node, a time-out threshold or a retry threshold for a switch based on received reports of performance of that switch.

10. (canceled)

11. (canceled)

12. A native computing device, comprising:
a first module to receive a first indicator of establishment of a communication path that enables an execution image to be written to the native computing device on behalf of a computing client that has reserved the native computing device, wherein the computing client is to be remotely disposed from the native computing device;
a second module, communicatively coupled with the first module, to reboot the native computing device in response to receive the first indicator; and
a third module to receive a second indicator of completion of the writing of the execution image to the native computing device;
wherein the second module is further to reboot the native computing device in response to receive the second indicator.

13. The native computing device of claim 12, further comprising:
a fourth module to execute preboot execution environment scripts to initiate a process for writing the execution image to the native computing device after reboot in response to receive the first indicator.

14. The native computing device of claim 12, wherein:
the first module is further to poll an asset management database for a second indicator of a status of the native computing device;
wherein receive the first indicator comprises detect a change in the second indicator.

15. (canceled)

16. (canceled)

17. (canceled)

18. (canceled)

19. (canceled)

20. (canceled)

21. A communication path management node, comprising:
a first module to receive an indicator of a native computing device to be reserved for a computing client and an indicator of an execution image to be written to the native computing device, wherein the native computing device, the computing client and the communication path management node are to be remotely disposed from each other;
a second module to cause a first communication path to be established to enable the execution image to be written to the native computing device on behalf of the computing client; and
a third module to, on completion of the writing of the execution image to the native computing device, cause a second communication path to be established for the native computing device to be available for computational use by the computing client.

22. The communication path management node of claim 21, wherein cause a first communication path to be established comprises:
determine a first port with which the native computing device is in communication; and
instruct at least one switch to switch the native computing device from the first port to a second port with which an imaging node is in communication, the imaging node configured to write the execution image to the native computing device.

23. The communication path management node of claim 22, wherein instruct at least one switch to switch the native computing device from the first port to a second port comprises perform one or more switch application programming interface calls.

24. The communication path management node of claim 22, wherein cause a second communication path to be established comprises instruct at least one switch to switch the native computing device from the second port to a third port in communication with the computing client.

25. The communication path management node of claim 22, further comprising:
a fourth module to receive the execution image from the computing client and cause storage of the execution image in a storage location accessible by the imaging node.

26. (canceled)

27. (canceled)

28. (canceled)

29. (canceled)

30. (canceled)

31. (canceled)

32. (canceled)

33. An imaging management node, comprising:
a first module to identify a first communication path between the imaging management node and a native computing device reserved by a computing client;
a second module to receive, from a database, an indicator of an execution image to be written to the native computing device; and
a third module to provide, to the native computing device, an indicator of a second communication path to enable the execution image to be written to the native computing device.

34. The imaging management node of claim 33, further comprising:
a fourth module to access preboot execution environment scripts stored at an accessible network location, the network location also to be accessible by the native computing device.

35. The imaging management node of claim 33, further comprising:
a fifth module to provide, to an asset management database, a report of a status of the native computing device on completion of the writing of the execution image to the native computing device.

36-50. (canceled)
